(19) United States
(12) Patent Application Publication
(10) Pub. No.: US 2019/0062042 A1
(43) Pub. Date: Feb. 28, 2019

(54) Coffee Beverage and Methods

(71) Applicant: Joshua Paul Wilbur, Santa Cruz, CA (US)

(72) Inventor: Joshua Paul Wilbur, Santa Cruz, CA (US)

(73) Assignee: Steeped, Inc., Scotts Valley, CA (US)

(21) Appl. No.: 15/684,528

(22) Filed: Aug. 23, 2017

(51) Int. Cl. B65D 85/808; B65D 81/20; B65D 65/46; B65D 65/40; B65D 85/812; B65D 75/52; B65B 29/02; B65B 7/02; B65B 31/00; B65B 61/20

(52) U.S. Cl. CPC B65D 85/8085; B65D 81/20; B65D 65/466; B65D 65/40; B65B 61/20; B65D 75/52; B65B 29/028; B65B 7/02; B65B 31/00; B65D 85/812

(57) ABSTRACT

A single-serve coffee package has an outer envelope having one folded edge and three heat-sealed edges, comprising 95% by weight materials that are compostable and demonstrate bio-degradability, a filter bag fully within the outer envelope, having one folded edge and sealed edges, forming a closed envelope having opposite sides, each side comprising one layer of filter material, fully compostable and biodegradable, the filter material exhibiting a plurality of openings through the material, enabling water to pass through, the openings having no dimension exceeding a minimum dimension, a volume of grains of ground coffee within the filter bag, dimensions of the grains precluding coffee grains passing through the openings through the filter material, and an atmosphere of gas within the outer envelope, enveloping the filter bag and the coffee grains, the gas inert relative to materials exposed within the outer envelope.

### BACKGROUND OF THE INVENTION

### 1. Field of the Invention

The present invention is in the technical area of coffee beverages, and pertains more particular to single-serve coffee apparatus, and to methods of making, marketing and distributing such apparatus.

### 2. Description of Related Art

It is well-known in the art to provide tea, and in some instances coffee, in a single-serve, packaged arrangement, such that coffee or tea may be made by adding hot water, or in some cases, cold water. However, existing systems for coffee in single-serve packages have considerable drawbacks. One drawback is that machines are required to push water through capsules. Another drawback is that single serve coffee has a negative effect on the environment as packaging is not recyclable or easily compostable. Another drawback is that the shelf life of these packages is quite short, and a user may never be sure to get fresh coffee. There are many other such problems, and there are many improvements that may be made.

What is needed in the art is a system for providing single-serve coffee in a manner that the coffee will be fresh, and that does not require a machine or special brewing equipment, and in a manner that packaging materials that are not consumed will be less harmful to the environment by being compostable and/or biodegradable. A need exists, as well, for ways to personalize coffee to individual users and enterprises.

### BRIEF SUMMARY OF THE INVENTION

In one embodiment of the invention a single-serve coffee package is provided, comprising an outer envelope having one folded edge and three heat-sealed edges, comprising 95% by weight materials that are compostable and demonstrate bio-degradability, a filter bag fully within the outer envelope, having one folded edge and sealed edges, forming a closed envelope having opposite sides, each side comprising one layer of filter material, fully compostable and biodegradable, the filter material exhibiting a plurality of openings through the material, enabling water to pass through, the openings having no dimension exceeding a minimum dimension, a volume of grains of ground coffee within the filter bag, dimensions of the grains precluding coffee grains passing through the openings through the filter material, and an atmosphere of gas within the outer envelope, enveloping the filter bag and the coffee grains, the gas inert relative to materials exposed within the outer envelope.

In one embodiment, the outer envelope is constructed as a laminate of three layers, an outer layer of the laminate being a transparent, reverse-printable layer. Also in one embodiment, a middle layer of the laminate is a barrier layer to gas and moisture, and an inner layer is a layer providing sealing characteristics for the envelope. In one embodiment, both the outer envelope and the filter bag are rectangular in length and width. And in one embodiment, the outer envelope has a maximum dimension of five inches, and the filter bag has a maximum dimension of three and one-half inches.

In one embodiment, the package further comprises a string and tag, both of all biodegradable and compostable material, the tag attached to one end of the string, and the filter bag attached to the other end of the string. Also in one embodiment, the package further comprises information and indicia printed to be readable on an outer surface of the outer envelope. Also in one embodiment, the ground coffee comprises a mass of from eight to twenty grams of coffee grains, inclusive. In one embodiment, the filter material of the filter bag is entirely woven material, entirely non-woven material, or a hybrid of woven and non-woven material. And in one embodiment, the filter bag is made of material derived from polyatic acid (PLA).

In another aspect of the invention a method for providing a single-serve coffee package is provided, comprising forming a filter bag with a folded edge and one open edge, the filter bag having opposite sides comprising each a single layer of compostable and biodegradable material, the filter material exhibiting a plurality of openings through the material, enabling water to pass through, the openings having no dimension exceeding a minimum dimension, placing a quantity of grains of ground coffee in the filter bag by the open edge, the grains all of dimensions precluding coffee grains passing through the openings through the filter material, sealing the open edge of the filter bag, enclosing the grains of ground coffee, placing the filter bag into an outer envelope having one folded edge, two heat-sealed edges, and one open edge, through the one open edge, the outer envelope comprising 95% by weight materials that are compostable and demonstrate bio-degradability, backfilling the outer envelope with an atmosphere of gas, enveloping the filter bag and the coffee grains, the gas inert relative to materials exposed within the outer envelope, and sealing the open edge of the outer envelope.

In one embodiment, the method further comprises constructing the outer envelope as a laminate of three layers, an outer layer of the laminate being a transparent, reverse-printable layer. Also in one embodiment, the method constructing the outer envelope with a middle layer of the laminate as a barrier layer to gas and moisture, and an inner layer as a layer providing sealing characteristics for the envelope. Also in one embodiment, the method comprises constructing both the outer envelope and the filter bag in rectangular configuration. And in one embodiment the method comprises constructing the outer envelope with a maximum dimension of five inches, and the filter bag with a maximum dimension of three and one-half inches.

In one embodiment, the method further comprises adding a string and a tag to the package, both of all biodegradable and compostable material, the tag attached to one end of the string, and the filter bag attached to the other end of the string. Also in one embodiment, the method further comprises printing information and indicia to be readable on an outer surface of the outer envelope. In one embodiment, the ground coffee is added as a mass of from eight to twenty grams of coffee grains, inclusive. IN one embodiment, the method comprises constructing the filter bag of entirely woven material, entirely non-woven material, or a hybrid of woven and non-woven material. And in one embodiment the method comprises constructing the filter of material derived from polyatic acid (PLA).

### BRIEF DESCRIPTION OF THE SEVERAL VIEWS OF THE DRAWINGS

FIG. 1 is an elevation view of a coffee brewing package according to one embodiment of the invention.

FIG. 2 is a side elevation section view of the brewing package of FIG. 1.

FIG. 3 is a perspective view of a pour-through product in an embodiment of the invention.

FIG. 4 is a perspective view of a three-layer laminate used in embodiments of the invention.

FIG. 5 is an elevation view of an exemplary automatic machine in an embodiment of the invention.

FIG. 6 is a process diagram, detailing processes, and relation of processes in an embodiment of the invention.

FIG. 7 is a network-architectural diagram in an embodiment of the invention.

FIG. 8 is an exemplary interactive interface presented to a customer in an embodiment of the invention.

### DETAILED DESCRIPTION OF THE INVENTION

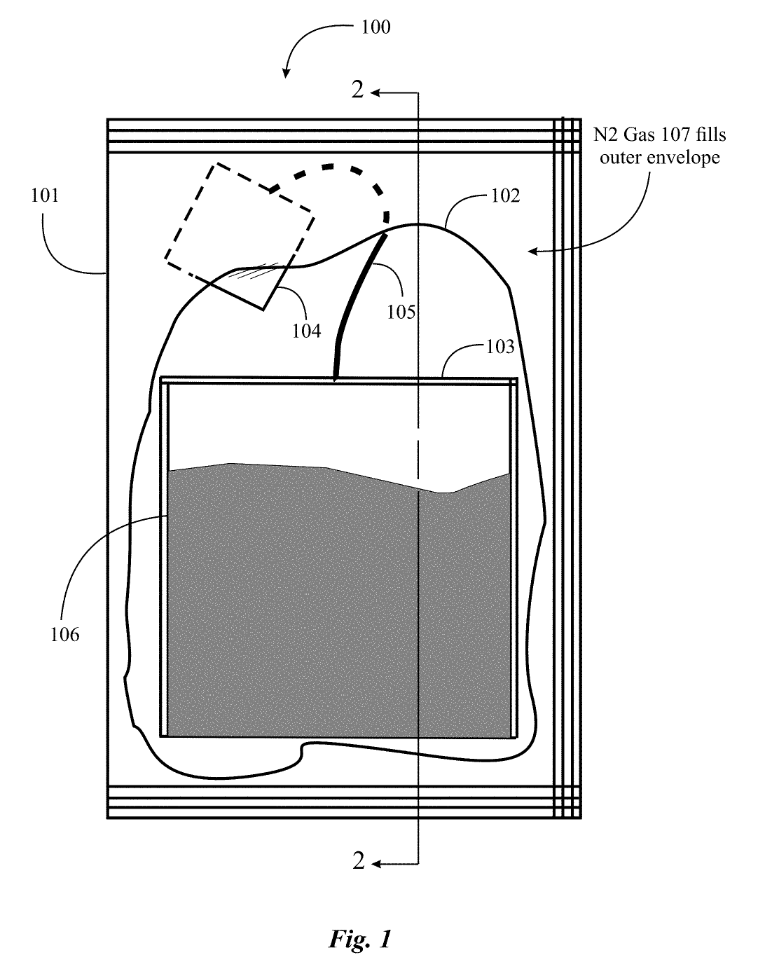

FIG. 1 is an elevation view of an end-use assembly 100, comprising a single-serve rectangular coffee filter bag 103, carrying ground coffee 106, the filter bag having a tag 104 connected to the filter bag by a string 105, all within a protective outer envelope 101, containing gas 107, in a form that may be provided to an end-user. The outer envelope is shown partially cut-away (line 102) to show the filter bag filled with ground coffee, with tag and string, and infused gas, within the outer envelope.

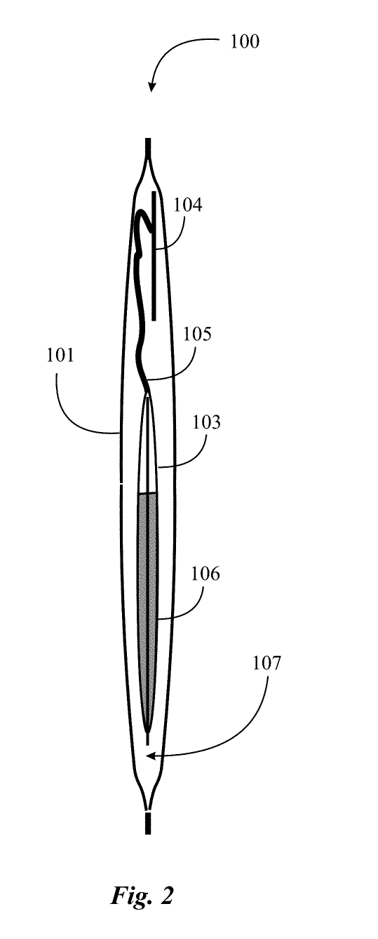

FIG. 2 is a side elevation view in section along section line 2-2, of assembly 100.

In this example, the filter bag is relatively large, roughly three inches by three and a half inches, providing ample surface for passage of water through the bag to the ground coffee within, and the overall dimensions of outer envelope 101 is about four inches by five inches. The filter bag in this example holds about 10-15 grams of ground coffee. In some embodiments, this range might be from eight to twenty grams, inclusive.

A simple operation for use is to tear open the outer notched envelope, to extract the filter bag holding the ground coffee, to place the filter bag in or over a cup or other container, and to provide hot water to immerse the filter bag, such that the ground coffee is steeped in the hot water. The filter bag in some embodiments is immersed in a cup of hot water, and in other embodiments, may be a part of a carriage that may fit over the lip of a cup, holding the filter bag in a manner that hot water may be poured over and through the filter bag, as described in further detail below. After steeping, the filter bag is removed and discarded, along with the opened, protective envelope.

It will be apparent that, over time and a lot of servings, there will be a substantial volume of used filter bags and opened protective envelopes to be discarded. In embodiments of the present invention most all components of the overall product are compostable and/or biodegradable. The point being that the enormous volume of otherwise waste elements, can be derived from renewable plant based materials, and can be expected to return to the natural elements from which they were formed.

A “biodegradable” product is renewable as the base materials are grown from the environment, and has the ability to break down, safely and relatively quickly, by biological means, into the raw renewable materials of nature from which they were formed, and disappear back into the environment. These products can be solids biodegrading into the soil (which we also refer to as compostable), or liquids biodegrading into water. Biodegradable plastics, papers, or fabrics can break down naturally or when exposed to microorganisms (a natural ingredient such as cornstarch or vegetable oil is added to achieve this result), or natural elements, such as heat. A product that is “compostable” is one that can be placed into a composition of decaying biodegradable materials, and eventually turns into a nutrient-rich material. It is almost synonymous with “biodegradable”, except it is limited to solid materials and does not refer to liquids.

Composting occurs in nature every day as fallen leaves and tree limbs biodegrade into the forest floor. The Environmental Protection Agency (EPA) considers composting a form of recycling because it turns resources into a usable product.

Considering first the inner coffee filter bags, element 103 in FIG. 1, there are several sorts of material that may be used in different embodiments. The material can be woven, non-woven fibers, or a hybrid of the two types, that is porous, of course, to allow water to flow in and out, while also keeping the coffee grounds within the bag, rather than escaping into the liquid result.

Considering first a woven construction, the offset of the weave determines the geometry and size (cross-section area) for each row and column in the woven material. There must be a compatible relationship between this geometry and the coarseness or fineness of the ground materials within. If any grains of the coffee are smaller than the opening of the weave, grains will escape in the steeping process. This threshold does not determine the fineness of the grind, but is just a required relationship.

It is, in fact, preferable that the grind be substantially fine, because the steeping process relies on interaction between grains of coffee and the hot water added. Concentration increases relative to time depending on surface area of coffee grains that are exposed to water, and the finer the grind, the more surface area is presented.

In regard to biodegradable material, there are several material options. One is Polylactic Acid (PLA), also known as a bioplastic. This is a is a biodegradable and bioactive thermoplastic aliphatic polyester derived from renewable resources, such as corn starch (in the United States and Canada), tapioca roots, chips or starch (mostly in Asia), or sugarcane (in the rest of the world). The PLA may be from genetically-modified organisms (GMO), such as vegetables, or Non-GMO, which may be organically grown, or grown with aid of fertilizers and chemical insecticides and the like. The sources in embodiments must be tracked and identified, and in many cases labeling is required, or in other cases advantageous. Highly desirable are biodegradable filter materials that are compostable, from non-GMO, organically raised sources.

In one embodiment, the filter material of bag 103 is a composite of finely-nonwoven PLA fabric from sources, in a composite form with nonwoven material, which may be fused in a heat sealing process, or in an ultrasonic sealing process. The nonwoven material, broadly defined as flat porous sheet or web structures bonded together by entangling fiber or filaments, may be applied in a manner to fine-tune the degree of permeability of the filter material relative to the degree of grind of the coffee.

In alternative embodiments bag 103 may be composed of all woven, or a hybrid of woven and non-woven material, a knit material, or composites, each of which may comprise biodegradable material, such as Non-GMO PLA (same with non-GMO corn used or made from materials like sugarcane, tapioca roots, or beats, and other options); or may comprise non-biodegradable standard bags, often made from plastics like synthetic Nylon, or cotton, polyester, polypropylene, flannel, and other materials. In some embodiments, compostable materials may be used as well. Such materials may be home compostable, or commercial compostable.

The string and tab, shown as elements 105 and 104, respectively, in FIGS. 1 and 2 in various embodiments, may comprise a combination of biodegradable, compostable, organic string, and a combination of biodegradable, compostable, recycled, organic tabs. In some embodiments, no string or tab is provided or is necessary. Tabs may be of different shapes and sizes than that shown in FIG. 1, and strings may be longer or shorter, or absent as mentioned above. In some embodiments tags may carry a logo or other graphic or alpha-numeric content. In other embodiments, a mechanism may be attached or unattached to squeeze, twist, or roll filtered bag to remove concentrated infused water within. These embodiments may include a device that twist string and squeezes bag, a pincher device that is used to independently grab and squeeze filtered bag, an embedded element in filtered bag that can be used to pull string through an opening putting pressure and squeezing the filtered bag, or an element that is embedded in the filter itself allowing torque to be applied to filter bag.

A filter bag size of three inches by three and a half inches was described above, and bags allowing empty space beyond dried ground materials are desirable, to a point, because they provide more filter area for the passage of hot water to steep the coffee grounds, and allow for the coffee to swell and absorb water. Bags may be larger and smaller in alternative embodiments. Further, a square shape is not a limitation. Bags may take any other shapes as well, such as sphere, round, oval, rectangle, or triangular. The square shape in the embodiment illustrated provides for a preferred filter area.

In one embodiment, bags are produced by folding over a single piece of woven, nonwoven or composite material, creating one folded edge, and the two adjacent edges, and an opposite edge are formed by adhesive ultrasonic sealing, heat sealing, or ultrasonic adhesive sealing, or sealing with fasteners. In FIG. 1 the folded edge of bag filter is the bottom edge, and the other three edges represent a sealed material. After folding, and sealing the two adjacent edges, coffee grounds are added through the single remaining opening. In one embodiment, the amount of coffee grounds added is about 12 grams. Then, after coffee grounds are added, the top edge is sealed, and in those embodiments where used, a string and tag are then attached, also by non-adhesive ultrasonic welding, heat, adhesives, or fasteners. Ultrasonic sealing is used in a preferred embodiment, creating clean edges with no glues or excess heat to damage product or packaging. In another embodiment, the string and tag are pre-attached to the filter material and may be wrapped around the bottom of the filter bag and the tag, attached with ultrasonic sealing, or another method, to the opposite side of the filter bag creating a tidy and manageable filter, string, and tag packet, which is more manageable with less loose elements to place into an outer envelope before flushing with a preserving gas and sealing.

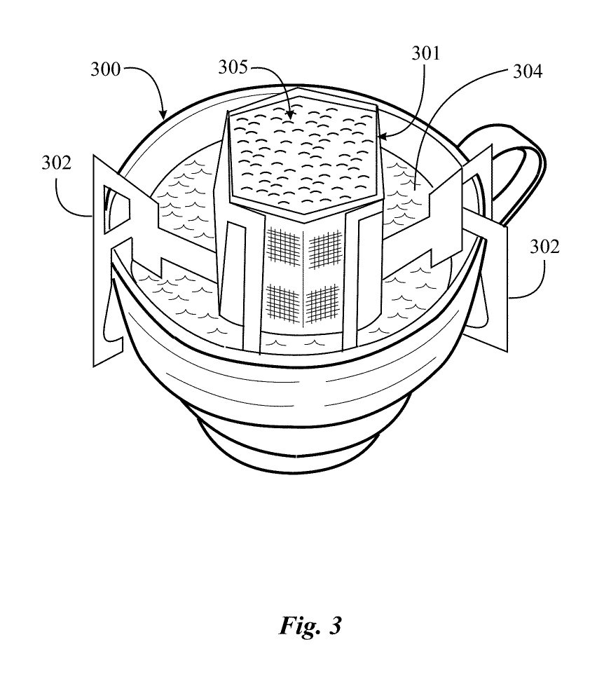

FIG. 3 illustrates a pour-through filter bag 301 in an alternative embodiment of the invention. Filter bag 103 in FIGS. 1 and 2 is made to be removed from the outer envelope, and to be dipped, retrievable and suspended by the tab and string, in liquid in a container, to steep coffee from the bag to the liquid. In the embodiment illustrated in FIG. 3, no string and tab is used. Instead filter bag 301 is integrated with one or more panels of perforated paper or paperboard, or other suitable material, which is joined to the outer surfaces of the filter bag material. The outer envelope 101 may be common to the embodiments. When envelope 101 is opened, and filter bag 301 is removed, the paper panels may be deployed by separating along the perforated lines, and extended to act as a hanger or mount on top of or around the edges of a drinking vessel. In one embodiment, filter bag 301 in closed along the top edge as stated in other embodiments, but may be opened along a pre-perforated line inset from the top edge of the filter. The filter bag, with panels 302 deployed, may be placed over a rim of a cup 300, exposing coffee grounds 305, such that hot water may be poured over and through the ground coffee and filter, making coffee beverage 304 in the cup.

In preferred embodiments of this fold-out, pour-through implementation, the paper or paperboard material is disposable and may be biodegradable and/or compostable, and/or made from non-GMO or organic sources. In other embodiments, plastic and conventional paperboard may be used. The filter material may be the same as described above for the closed filter bag implementation with string and tag.

In some embodiments directions for use, and/or other information may be printed on the paperboard elements of the pour-through implementation. The ink used for such embodiments may be soy-based, vegetable-based, mineral-based, or water-based to adhere to the preferred features of biodegradable or compostable components.

It will be apparent to the skilled person that there are a variety of ways that filter assemblies may be designed and manufactured to provide pour-over, and drip-through features. For example, the bags themselves in these embodiments may take different shapes, such as conical or cylindrical or any combination where a supportive material element is used in combination with a drinking vessel to help suspend a filter material containing ground coffee where liquid can be poured over a vessel and onto coffee.

In other embodiments, panel 302 may be present in other shapes and placement combination. In one embodiment, there are two perforated arms that extend horizontally to attach to the drinking vessel with a third point that folds in to create a lip to hold the filter bag on top of the vessel. In another embodiment, the supportive sides extend out like an accordion and rest on top of the drinking vessel likes walls, by which an inner filter is suspended, allowing water to be poured over the coffee and filter through the center of the apparatus. In other embodiments, utensils or tools are provided to use in conjunction with the filter bag to help suspend the filter on top of or over the drinking vessel. In one embodiment, a stick-like rod is provided to use in conjunction with a pour over filter bag, where the filter has holes, allowing the rod to be placed through the opposing holes to allow the rod to rest on the top edge of a drinking vessel and the filter to hang off of the rod. In other embodiments, there can be different shape and amounts of tools provided, working in relationship with the filter bags.

In preferred embodiments of the invention outer envelope 101 is provided to enclose the filter bag containing coffee, and other elements that may or may not be implemented along with a filter bag. In a preferred form, this outer envelope is constructed of three laminated layers of materials, comprising 95% by weight materials that are compostable and demonstrate bio-degradability. In other embodiments, the envelope may be one, two, or various multiple layers of laminate materials, and may be made of other materials, such as petroleum-based products.

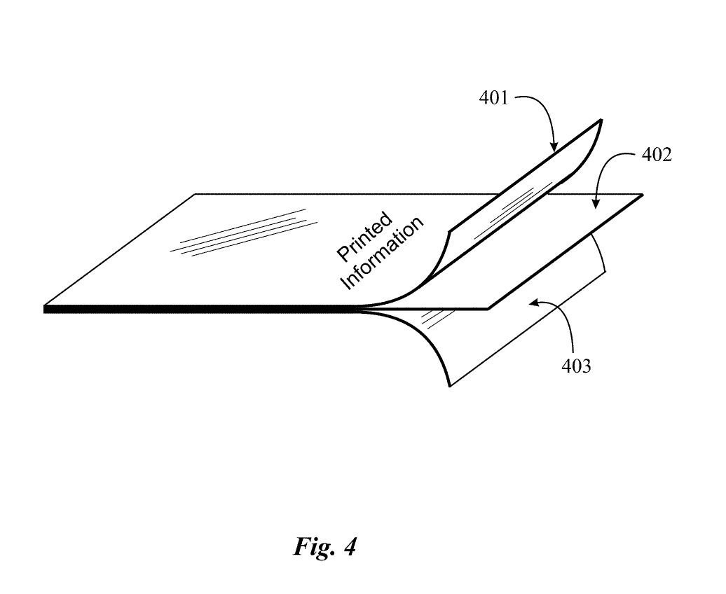

FIG. 4 is an illustration showing three layers 401, 402 and 403 in a laminated construction in a preferred embodiment, for material of outer envelope 101 of FIGS. 1 and 2. Layer 401 in this example is the outer layer in the three-layer composite that is used for the outer envelope. In a preferred embodiment, this outer layer comprises a reverse-printable clear barrier so inks may be locked in the packaging. In this preferred embodiment, the outside layer maintains barrier properties to protect inner product, and is, in one embodiment, 0.75 Mil compostable cellophane, biodegradable, renewable, sustainable, non-GMO material made from plants (cellulose).

In many applications and embodiments, it is desirable to print information, backgrounds and/or graphics to be visible on the outer envelope. Such printed information might, for example, detail the contents of the envelope, such as the particular brand or type of coffee, and other ingredients, the amounts of ingredients, and so on. Printed information may also detail instructions for opening and use, and may provide color and logo for branding purposes. In other embodiments, printing may be done on the outside of packaging layer or not at all, and material may be transparent or solid in color.

This outer cellophane material is also printable on the outer surface, but may also be provided as a transparent layer which is reverse-printable on the inner surface, which, when the laminate is accomplished, provides security for the printing. The phrase “printed information” shown on (or under) outer layer 401, represents this printed material. In alternative embodiments, the envelope may be one, two layers or multiple layers, or comprised of petroleum-based materials.

Middle layer 402 in FIG. 4 is, in a preferred embodiment, a barrier layer to gas and moisture, and comprises a metalized cellophane barrier layer as 0.75 Mil, compostable material, made from trees (cellulose). Layer 402 has all the embodiments of layer 401 with the added character of metallization. In a preferred embodiment, the metalized layer is a thin layer of spayed aluminum over a clear biodegradable material.

Inner layer 403 in FIG. 4 is, in a preferred embodiment, a sealing layer, comprising 35 Mil, which reacts to heat to create a strong envelope seal-strength, and is also made from bio-based materials that are fully compostable. In other embodiments layers of envelope materials can be in any order, thickness, transparency, flexibility, combination, or origin. In other embodiments, the laminate layers are each glued together with solvent glues to adhere them to one another. In a preferred embodiment, the glues used to adhere laminate layers are biodegradable and/or compostable.

In general, the outer envelope is constructed from roll stock, as is described in enabling detail below, in a manner that a length of the laminated film is folded, providing one folded edge, after which the two other edges are made, preferable heat sealed, leaving the final edge opened, as a portioned section is simultaneously cut from the roll stock, allowing an individual envelope to be formed, providing a single opening to one side of bag, which is subsequently filled with the filter bag assembly, containing coffee grounds. Then the third and final edge is heat sealed, as the filter bag drops into the envelope, as nitrogen gas is injected into the envelope upon sealing. The folded edge may be seen as the one edge not showing three heat sealing lines in FIG. 1. The bottom and top edge, and opposing side edge are seen as being sealed in three lines parallel by processing.

In a preferred embodiment, during the processing, the envelope being formed is injected with gaseous nitrogen, before the top is sealed, gaseous nitrogen is caused to fill the bag. The nitrogen gas forestalls oxidation. In other embodiments, other gases or valves may or may not be used to keep the coffee fresh by reducing oxidation. In other embodiments, oxygen absorption substances may be added to absorb oxygen rather than replacing it.

Nitrogen gas used in preparation and packaging is provided in a preferred embodiment by a nitrogen generator machine. In some instances, nitrogen air membrane filter, or pure nitrogen gas tanks may be used.

The principal raw material for cellophane flexible packaging is cellulose, a renewable raw material, from trees. A plurality of single-serve packs are placed in an outer box for storage and shipment to end users, retailers, and other distribution outlets. The outer box may be of different dimensions, depending on the size and number of single-serve packs to be accorded each box. The outer boxes will, in a preferred embodiment, be of 100% recycled material, 100% post-consumable material made with wind energy or renewable energy and/or credits. Printing on the outer box is biodegradable, non-toxic vegetable, mineral, water, or soy-based inks.

In one embodiment, the outer box has a perforated tear-away tab at the end so single bags may be removed conveniently from box. In this implementation, the outer box may be 4″×5″×5″. In other embodiments, there may be other orientations of tear-away perforated openings to allow for convenient access. There may also be no tear-away portions for different commercial and bulk uses.

In a preferred embodiment, all boxes are printed with vegetable-based inks or soy-based inks. These inks are better for the environment, produce less VOC's (Volatile Organic Compounds), and are made with renewable resources such as soy, linseed, and corn. Petroleum-based inks are not used in preferable circumstances. Through preferred processes when printing on boxes, a solvent recycling system recovers and recycles all waste solvents used in the sheet-fed press operations, creating 80% less landfill waste.

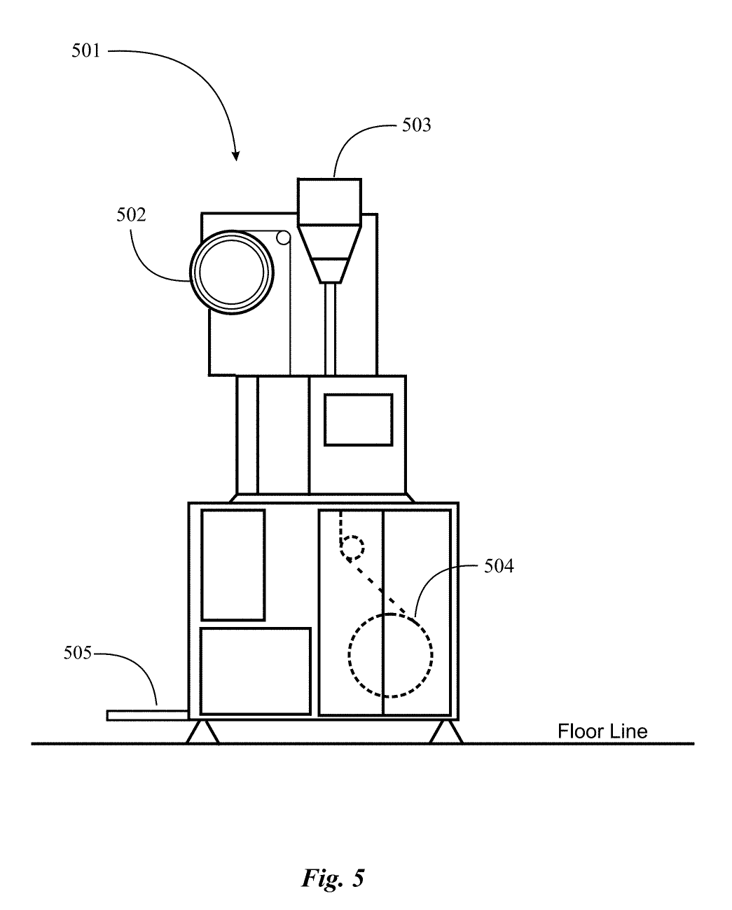

FIG. 5 is an outline view of a machine 501 that may be used in production of single serve coffee packs in embodiments of the present invention. This machine view is exemplary only, and represents one of various commercially-viable machines that may be utilized, with certain alterations and proprietary operation, in embodiments of the present invention.

In this example filter bag material is provided to machine 501 in a continuous roll 502. The filter material may be woven or nonwoven, or a hybrid of each, as described in more detail above. In some embodiments, such as filter bag 103 of FIG. 1, the material on the roll is all filter material or all filter material with string and tag attached. In some embodiments, the material of the roll is pre-prepared with plastic or paper components to provide a suspension, pour-through bag, such as shown in FIG. 3 as element 301.

As the filter material enters the machine, it is folded lengthwise, providing a bottom folded edge as seen in FIG. 1. A side seal is made, and a side opposite sealed is made for a specific length, providing an open-top filter bag opposite the folded edge. As each bag is formed it is filled with ground coffee that has been introduced at entrance funnel 503. In one embodiment, the amount of coffee and/or dried beverage components are a function of time of operation. In another embodiment, additional equipment weighs and dispenses coffee by volume or weight. Filled bags are sealed, in preferred embodiments, ultrasonically, and a string and tag are pre-attached, or in certain embodiments attached throughout the process.

Envelope material is fed from roll 504, folded in a similar manner to the filter bags but the folded edge is on the side, and the sealed edges are on the top, bottom, and opposite side to form the envelope. The opening is at the final sealed edge, where the completed and filled filter bags are inserted one-at-a-time into this outer envelope. In a preferred embodiment, the filter bag is inserted into the outer envelope under an atmosphere of nitrogen, which flushes out air in the outer envelopes, then the outer envelopes are sealed across the final opening, preferably by a heat sealing process. In other embodiments, outer envelopes may be created with alternative configurations, including top and bottom seals with a third seal in the middle of the back of the envelope. Markers may be added at specific points on the laminated envelope roll stock to trigger operations of the machine as material advances, such as automatically advancing and cutting material. Finished product exits the machine to be boxed at an output tray 505, in a preferable embodiment with a conveyer belt carrying the individual product packs away from the machine, where applicable product packaging boxes may be automatically erected, product is inserted, boxes are automatically sealed, boxes are collected to be packed into larger case, and cases are added onto pallets, where any product is then stored and shipped.

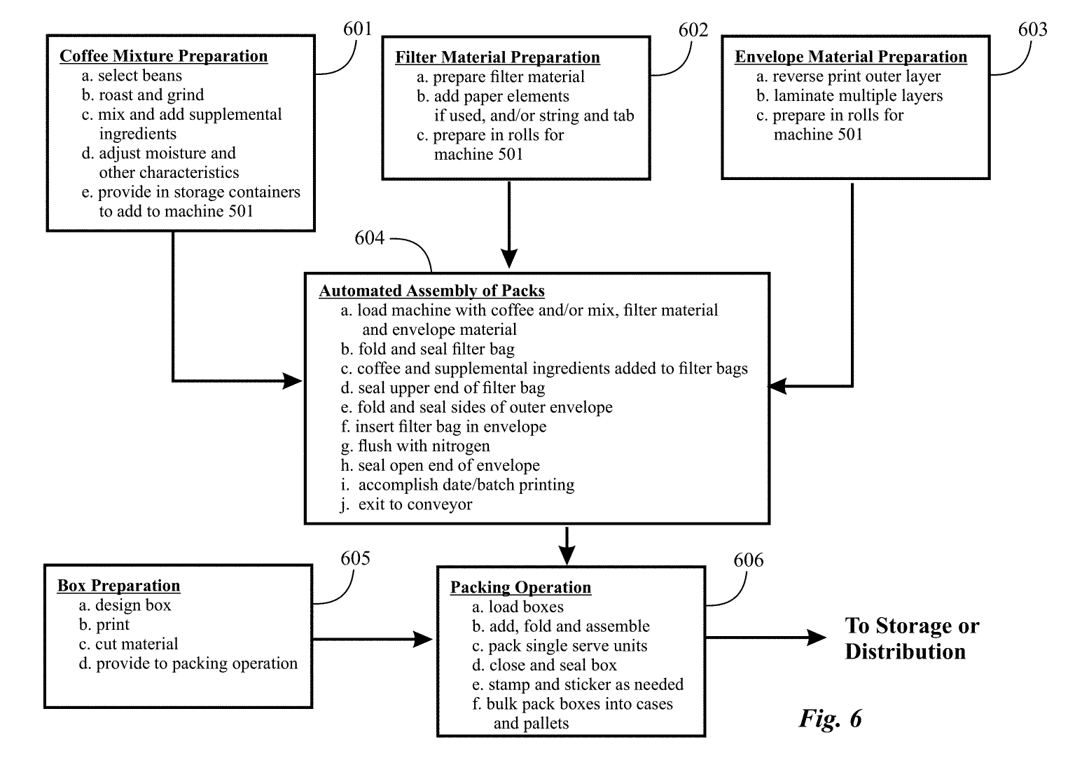

FIG. 6 is a diagram depicting processes involved in production, at least at a macro-level. There are six or more processes involved, comprising series of actions that are closely associated.

At process 601 coffee or dried beverage component mixture is chosen and prepared. In a preferred embodiment, coffee beans being sourced are beans adhering to the highest quality and qualified as directly traded coffee over the Fair Trade pricing standards. This, at molecular level, is a process of selecting one (a single origin bean), or multiple different coffee beans (blends). Beans are specifically roasted for specific flavor and strength profiles. These beans are roasted and then ground in a specific timeframe to allow for degassing of carbon from beans and before oxidation makes ground coffee stale. Supplemental ground dry beverage components are then added if applicable and all dried beverage components are then mixed. Grind size of coffee is specific to achieve the ideal flavor and caffeine extraction, where a smaller sized grind will yield more surface area and more extraction, and a larger grind will prevent grind from leaving the filtered bag. Filter bags are specifically designed to allow for maximum water permeability while containing coffee grinds. In a preferred embodiment, coffee grinds are uniform between 400-600 microns in diameter with less than 15% falling outside that threshold. Specific grinders are used in the grinding process to ensure consistent grind size, while also keeping the grinding process cool as to avoid cooking the beans after roasting has already been completed.

In some circumstances, and for some products, there are supplemental ingredients that may be added at this step. For example, sugar, honey, and/or other sweeteners may be added at his step, and/or other dry beverage components for example dairy or non-dairy creamer options, and/or supplements and/or herbs. There are a number of ways this may be done. Ground material may be added to the coffee grinds, or material may be added, for example, by spraying the ground coffee, to provide a coating on the grinds that may be absorbed in solution before the coffee is steeped. Some ingredients may be liquid, some may be in crystal and/or dried form. The way in which the ground material is finally prepared will depend a great deal on the supplemental ingredients to be added.

Other than sweeteners, other flavoring ingredients may be added. These may, in different embodiment, be herbal, liquid, crystal, or ground material, or in other forms. There may be very special cases where medicinal and/or pharmaceutical ingredients may be added. In very special circumstances, for example, single serving coffee units may be a delivery vector for additives for either medicinal and recreational purposes.

Further to any supplemental ingredients, other steps may be taken to adjust moisture in the ground mix, or to bake or otherwise irradiate the mix. At the end of these preparatory steps, the ground mix, with all ingredients, is placed in storage containers in proper amounts to be added at need to hopper 503 of machine 501, and/or to a supplemental hopper work in unison with hopper 503 to achieve similar delivery results into a machine for packaging. In another embodiment, supplemental ingredients may be added to supplemental packets made of any material whether physically disposable or dissolvable to compliment the end beverage experience.

At process 602, filter material is prepared. This process may involve selecting a material, woven or non-woven, and may involve combining a woven with a non-woven material to produce a hybrid material, and combining that material with a method, which may include but is not limited to a steeped filter bag method or a pour-through method. The permeability of the prepared filter material will associate closely with the degree of grind of the ground coffee mix and/or dried beverage components. In some embodiments paper panels, perforated for deployment as pour-through units, may be added to the filter material, and in a pattern to provide proper elements for individual bags or pour-through units. In another preferred embodiment, strings and tabs are added to the filter. The prepared filter material is provided in rolls to the automated process with machine 501, but in other embodiments may be presented to a machine or packaging process as individual filters, envelopes, and/or bags.

At process 603, outer envelope material is prepared by reverse printing on an outer layer, if defined for a particular product, after which the multiple layers are laminated, and the material is prepared in rolls for provision to automatic process machine 501. In other embodiments envelope, material may be presented to a machine or packaging process as individual envelopes and/or bags. In another embodiment, outer envelope material can be laminated first and then printed on the outside of the film and sealed with a UV treatment process, an electron beam curing process, or any process that helps seal and/or cure the ink on the roll so it does not migrate onto the inner side of the roll material.

Processes 601, 602, and 603 all feed into process 604, which is the detailed process performed in machine 501. Machine 501 is loaded with the coffee mixture, including supplemental ingredients when applicable. The machine, folds and seals filter bags, leaving one opening in each bag. The ground coffee mixture is added to the open side of the filter bags, after which the openings are sealed. In parallel to the formation and filling of the filter bags, envelopes are formed, each packed with filled filter bag inserted into the outer envelope, which is then flushed with nitrogen, as the open end of the envelope is sealed. The finished single-serve packets are placed on a conveyor away from machine 501. In some embodiments nitrogen is flowed into machine compartments to increase purity levels. In a preferred embodiment, oxygen levels are kept beneath 2% oxygen and tested regularly as part of the process.

Process 605 defines preparation of design files and boxes for the single-serve packets, which may be packed and sold in boxes of several units. In one embodiment, twelve packets to a box. Material is cut for boxes in a typically automated operation, boxes are printed, then assembled and prepared for packing operations. Perforation lines may be added, and adhesives and the like. Finished boxes are provided to packing process 606. In one embodiment, finished boxes are flat and designed to be fed into an automated box forming, stuffing, and sealing machine.

In process 606, boxes are presented, packets are added, boxes are closed and sealed. Stamps or stickers, or other codes, such as date and time, may be added, and loaded boxes may be bulk packed into larger boxes, and larger boxes may be packed onto pallets, which are then provided to storage and distribution operations.

In some implementations and embodiments products are produced and shipped as though they are products of another enterprise or organization. The embodiments in this process is referred to as white labeling or co-packing. When white labeling, the same process is applied but uses the branding of particular enterprise or organization customers to give the appearance of ownership. The product is designed, and all variables are set and agreed to in interaction with the customer, and saved for use at production times. The product is designed, produced, printed, and branding and the like is done to show that this particular product is a product of that particular enterprise or organization. Examples might include single serve coffee packets for a hotel brand, or airline, or coffee roaster, white labeling for hospitals, for retail stores, and many, many more.

In some embodiments of the invention products are distributed and sold through groceries and other natural outlets, through white labeling for third-party enterprises and organizations, branded to those third-party organizations and enterprises, and in some embodiments, product is sold on-line directly to individual consumers.

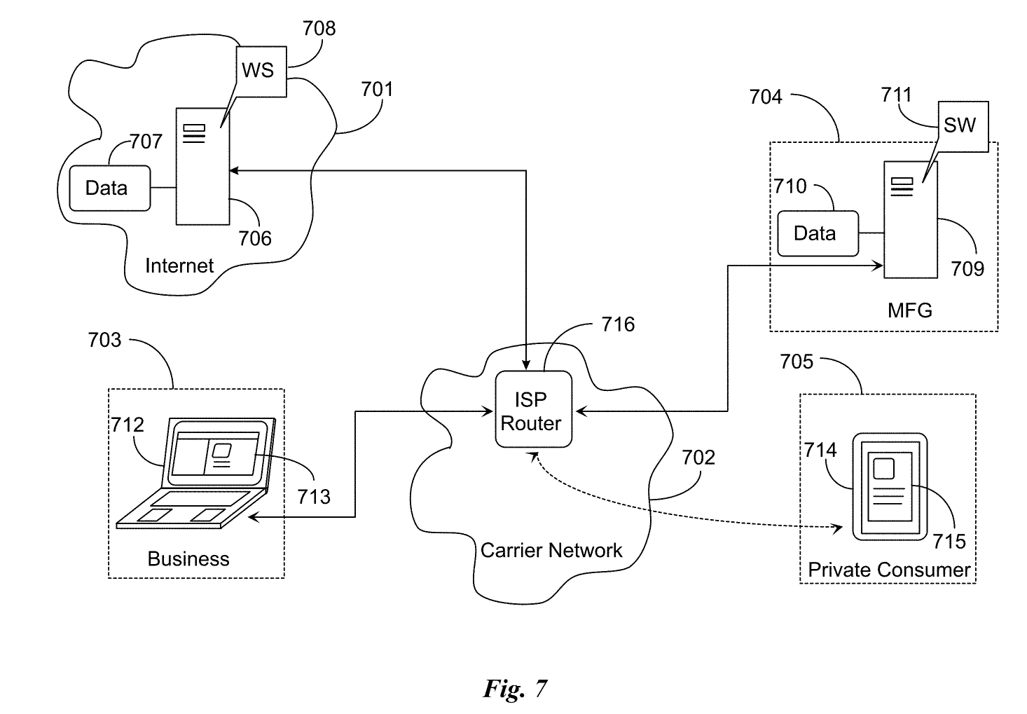

FIG. 7 is an architectural diagram illustrating architecture for enterprises and individuals to interact with a web site of an enterprise that produces the single-serve packets that are described in enabling detail in this specification. In this architecture, businesses and other enterprises 703 are connected by computer appliances, such as a laptop 712 shown, through an Internet Service Provider (ISP) 716 in a carrier network 702 to a server 706 connected in in the well-known Internet network 701. This server executes software 708, which provides a web site, and has a connected data repository 707.

Private individuals 705 may use computerized appliances, such as a smartphone 714 shown, through ISP 716 to also interact with web site 708 through server 706. A manufacturer of single-serve coffee packets, described in enabling detail herein, is represented by server 709, with data repository 710, executing software (SW) 711. It is intended that web site 708 is hosted on behalf of the manufacturer.

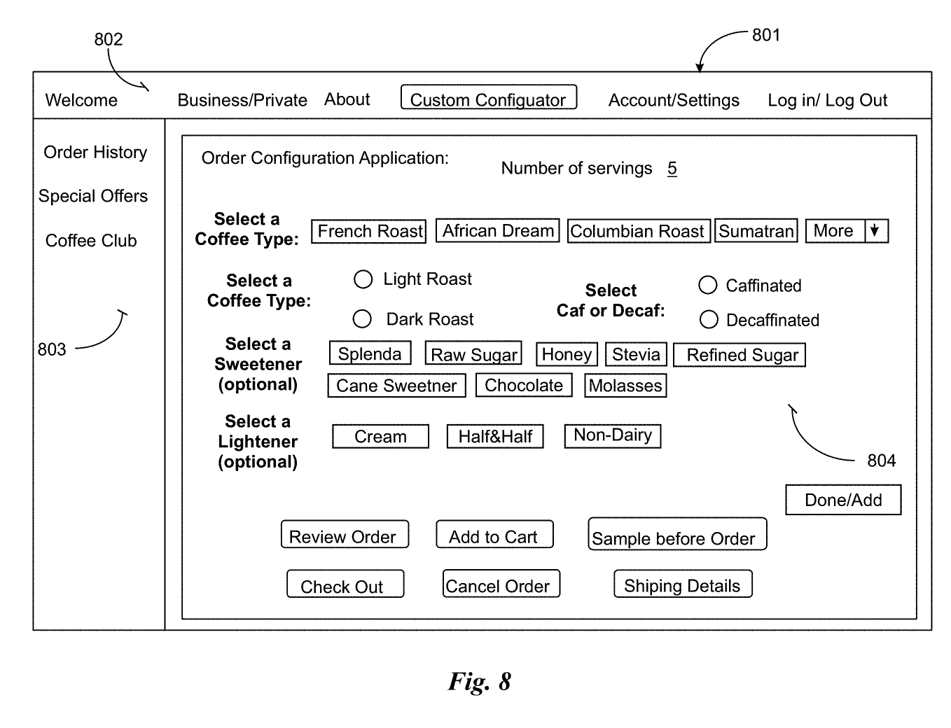

FIG. 8 is an exemplary interactive interface provided to private individual customers and enterprises connecting with web site 708. This interface may be displayed on platform 712 as display 713, and on smartphone 714 as display 715. There may additionally be a plurality of other interactive interfaces that may be provided for customers through web site 708.

Assume, for sake of description, that manufacturer 704 has four types of coffee one may select, these being French Roast, African Dream, Columbian Roast, and Sumatran. Available types of each may include Light Roast, Dark Roast, Caffeinated, and Decaffeinated. Sweeteners available may be none, Splenda, raw sugar, honey, and Stevia. Creamer options may be none, dried or liquid non-dairy, dairy, animal based or non-animal based. Assume these are the sweetener choices, although other choices are shown in FIG. 8. Assuming that choices are exclusive, that is, that one may have only one brand with one type (such as decaf) with either none or one sweetener (ignoring how much sweetener), there are eighty combinations. If three different levels of sweetness are considered, 240 combinations.

Since the restrictions in this example are strict, it may be understood that this process allows for a great deal of personalization. In embodiments of the invention, one of the objects is to free consumers from the necessity to carry lighteners, sweeteners, and the like, and to add same to cups of coffee. In the inventive form, all of the supplemental ingredients are included in the single-serve packet, and all of the options are accomplished in the single, fully immersed steeping or pour-through process.

So, as an example, an individual customer, using platform 714, might define a particular end product out of the many combinations available, and in one embodiment the customer may author a name for that particular product, which will be saved in that customer's profile, allowing that customer to choose among previously-saved recipes when ordering. It may well be that another customer may define a personal product with the exact same recipe, but author a different name. No problem, the recipe is associated with the name in the personal profile of each customer.

The inventor contemplates many more brands and types of coffee, and a great variety of flavorings, sweeteners, lighteners, and the like, and the available recipes that may be created will be in at least tens of thousands. In one embodiment, each variable for a customer will be represented by a radio button or other link on a high-level page for a customer who is registered, has a profile, and is logged in. Upon activating a link for, say, coffee brand (French Roast, Columbian), all of the available brands will be displayed by name in another interactive link. Activating one of these links will present a story about that coffee brand, which may include specifications, geography where raised, videos, related stories, and much more. Other advice may be suggested for the customer as to social situations for this brand.

A significant depth of information and the like may be provided for each variable that may be presented to a customer in this way, and the customer can author and create a variety of recipes for different situations, locales, times-of-day and the like.

In one aspect of the invention semi-automatic machines are made available to knowledge workers in the parent organization, allowing a customer to create, and then order a test quantity of the created recipe. Pricing is graded in a manner that costs are at least covered in the process, and reorders, and quantity orders are priced accordingly. In another embodiment, automatic machines are able to produce choices per order in a time appropriate manor.

In another embodiment, users will be able to socially share and interact regarding their platform choices and creations. In one aspect, a chat process is maintained through the website allowing a customer to tout his or her creations, and to communicate with other customers regarding these creations. All creations and orders are archived in an order history archive, and creations that are widely used may be singled out for rewards and honors. In another embodiment, orders are optimized to be automatic repeating subscriptions.

In many aspects, not all variables may be made available to all customers for creative endeavors. Some possible ingredients, such as pharmaceuticals, recreational drugs, may be severely restricted, and under regulatory review in different jurisdictions. Many of these variables may be available only for white labeling projects with enterprises that are licensed and enabled to deal with certain variables, such as prisons, mental institutions and hospitals. Some special availability of variable may be made to physicians, psychologists and psychiatrists, for example.

In another embodiment, a coffee single-serving-cup includes coffee grounds built into or as part of the cup of the invention, whether built into the bottom behind a filter, adhered to the inside of cup so when a user adds water to the cup your coffee is made, or encompassing a water dissolvable packet that disappears with use. When finished, a further embodiment, encompasses a cup that is compostable and/or the entire serving cup is biodegradable. Single-serving-cups with integrated coffee and/or dried beverage components can be packaged as stacked units, for example by a hot water jug for convenient use and limited preparation necessary.

In another embodiment, a double chamber pouch that encompasses two filter bags vs. one is provided, which allows for a combination of a bigger gauge filters with increased water/air permeability, while also still holding beans in a lesser gauged complimentary pouch.

In another embodiment, a larger filter bag for steeping a whole pot of coffee is provided. For example, for whole groups while camping, placing a larger filter bag in a larger thermos, where in a preferred embodiment the filter bag is biodegradable and/or compostable.

In another embodiment, an iced coffee or cold brew steeping bag for a longer steep time in cold water is provided.

In another embodiment, a steeping bag made for brewing cascara tea, the husk of the outer cherry of the coffee bean, is provided. In another embodiment, the outer husk of the coffee cherry is presented as a product in unison with the roasted coffee bean from within that same batch of outer cherry's presenting a full coffee tasting experience of the same husk with the inner bean.

In another embodiment, a tag may be attached to a string that sticks to a side of a cup. The tag can be a sticker, half sticker, or adhesive element whose paper back material is pulled off of to reveal a sticky strip. The sticky tag serves to allow a user to stick tea tab to side of cup or container to avoid losing the string and/or tab in water and/or drinking vessel.

In another embodiment, concentrated liquid coffee is placed in a canister, tube, or packaging, so the user only needs to add water to a vessel to achieve ideal coffee strength, preparation, and drinkability.

In another embodiment, an open brewing filter bag is placed over the edge of the entire cup with the filter bag in the cup. The top of the filter bag has a mechanism, for example elastic, drawstring, adhesive, etc., that helps the filter stay secure over lid of drinking vessel. Water is poured directly into open filter and onto coffee grounds. With an open lid, a user is able to stir while preparing beverage and then simply pull opening of bag shut before removing the filter and the coffee in it out of cup leaving behind brewed coffee with no remaining grinds or filter.

It will be apparent to the skilled person that the embodiments described in this specification are exemplary only, and that different products may be defined and provided through a great variety of combinations and quantification of various variables, and that all such combinations, although not specifically described in this specification may be considered another aspect or embodiment of this invention. The limitations on the invention are defined only by the claims that are presented below.

1. A single-serve coffee package, comprising:
an outer envelope having one folded edge and three heat-sealed edges, comprising 95% by weight materials that are compostable and demonstrate bio-degradability;
a filter bag fully within the outer envelope, having one folded edge and sealed edges, forming a closed envelope having opposite sides, each side comprising one layer of filter material, fully compostable and biodegradable, the filter material exhibiting a plurality of openings through the material, enabling water to pass through, the openings having no dimension exceeding a minimum dimension;
a volume of grains of ground coffee within the filter bag, dimensions of the grains precluding coffee grains passing through the openings through the filter material; and
an atmosphere of gas within the outer envelope, enveloping the filter bag and the coffee grains, the gas inert relative to materials exposed within the outer envelope.

2. The package of claim 1 wherein the outer envelope is constructed as a laminate of three layers, an outer layer of the laminate being a transparent, reverse-printable layer.

3. The package of claim 2 wherein a middle layer of the laminate is a barrier layer to gas and moisture, and an inner layer is a layer providing sealing characteristics for the envelope.

4. The package of claim 1 wherein both the outer envelope and the filter bag are rectangular in length and width.

5. The package of claim 4 wherein the outer envelope has a maximum dimension of five inches, and the filter bag has a maximum dimension of three and one-half inches.

6. The package of claim 1 further comprising a string and tag, both of all biodegradable and compostable material, the tag attached to one end of the string, and the filter bag attached to the other end of the string.

7. The package of claim 1 further comprising information and indicia printed to be readable on an outer surface of the outer envelope.

8. The package of claim 1 wherein the ground coffee comprises a mass of from eight to twenty grams of coffee grains, inclusive.

9. The package of claim 1 wherein the filter material of the filter bag is entirely woven material, entirely non-woven material, or a hybrid of woven and non-woven material.

10. The package of claim 1 wherein the filter bag is made of material derived from polyatic acid (PLA).

11. A method for providing a single-serve coffee package, comprising:
forming a filter bag with a folded edge and one open edge, the filter bag having opposite sides comprising each a single layer of compostable and biodegradable material, the filter material exhibiting a plurality of openings through the material, enabling water to pass through, the openings having no dimension exceeding a minimum dimension;
placing a quantity of grains of ground coffee in the filter bag by the open edge, the grains all of dimensions precluding coffee grains passing through the openings through the filter material;
sealing the open edge of the filter bag, enclosing the grains of ground coffee;
placing the filter bag into an outer envelope having one folded edge, two heat-sealed edges, and one open edge, through the one open edge, the outer envelope comprising 95% by weight materials that are compostable and demonstrate bio-degradability;
backfilling the outer envelope with an atmosphere of gas, enveloping the filter bag and the coffee grains, the gas inert relative to materials exposed within the outer envelope; and
sealing the open edge of the outer envelope.

12. The method of claim 11 further comprising constructing the outer envelope as a laminate of three layers, an outer layer of the laminate being a transparent, reverse-printable layer.

13. The method of claim 12 comprising constructing the outer envelope with a middle layer of the laminate as a barrier layer to gas and moisture, and an inner layer as a layer providing sealing characteristics for the envelope.

14. The method of claim 11 comprising constructing both the outer envelope and the filter bag in rectangular configuration.

15. The method of claim 14 comprising constructing the outer envelope with a maximum dimension of five inches, and the filter bag with a maximum dimension of three and one-half inches.

16. The method of claim 11 further comprising adding a string and a tag to the package, both of all biodegradable and compostable material, the tag attached to one end of the string, and the filter bag attached to the other end of the string.

17. The method of claim 11 further comprising printing information and indicia to be readable on an outer surface of the outer envelope.

18. The method of claim 11 wherein the ground coffee is added as a mass of from eight to twenty grams of coffee grains, inclusive.

19. The method of claim 11 comprising constructing the filter bag of entirely woven material, entirely non-woven material, or a hybrid of woven and non-woven material.

20. The method of claim 11 comprising constructing the filter of material derived from polyatic acid (PLA).
